(19) United States
(12) Patent Application Publication
(10) Pub. No.: US 2026/0227796 A1
(43) Pub. Date: Aug. 6, 2026

(54) SYSTEMS AND METHODS FOR PATH PLANNING

(71) Applicant: ZHEJIANG HUARAY TECHNOLOGY CO., LTD., Hangzhou (CN)

(72) Inventors: Yidong JIN, Hangzhou (CN); Jiangtao CHEN, Hangzhou (CN); Wei LU, Hangzhou (CN)

(73) Assignee: ZHEJIANG HUARAY TECHNOLOGY CO., LTD., Hangzhou (CN)

(21) Appl. No.: 19/630,498

(22) Filed: Mar. 27, 2026

Related U.S. Application Data
(63) Continuation of application No. PCT/CN2024/101197, filed on Jun. 25, 2024.

(30) Foreign Application Priority Data
Sep. 28, 2023 (CN) 202311280478.X

(51) Int. Cl. G05D 1/644; G05D 1/246; G05D 109/10

(52) U.S. Cl. CPC G05D 1/644; G05D 1/246; G05D 2109/10

(57) ABSTRACT

The present disclosure provides methods and systems for path planning. The methods may include obtaining posture information of a moveable subject and a path map. The moveable subject may be located at a current position in the path map and plan to go to a target position in the path map, the path map may include path nodes and path segments, and each of the path segments may connect two path nodes of the path nodes. The methods may include determining, based on the posture information of the moveable subject, one or more target path segments from the path segments in the path map. The methods may also include determining one or more candidate starting nodes based on the one or more target path segments. The methods may further include determining a target starting node from the one or more candidate starting nodes.

### CROSS-REFERENCE TO RELATED APPLICATIONS

This application is a Continuation of International Application No. PCT/CN2024/101197, filed on Jun. 25, 2024, which claims priority of Chinese Patent Application No. 202311280478.X filed on Sep. 28, 2023, the contents of each of which are hereby incorporated by reference.

### TECHNICAL FIELD

The present disclosure generally relates to the path planning field, and more particularly, relates to systems and methods for determining target starting nodes in the path planning field.

### BACKGROUND

When a movable subject (e.g., an automated guided vehicle (AGV)) moves along non-fixed paths in a certain scenario (e.g., a factory), some problems (e.g., collisions, congestion, management difficulties, etc.) need to be taken into consideration. To reduce or solve these problems, a topology map of paths that the movable subject can move along (also referred to as a path map) is established based on real environment of the certain scenario, and a preset path is planned for the movable subject based on the path map. Finally, the movable subject is guided to move along the preset path through positioning device(s) of the movable subject and/or positioning markers.

However, conventional path planning approaches for the movable subject usually assume that the movable subject is located at an ideal position, such as, a path node on the path map. However, in real scenarios, due to human intervention, task requirements, abnormalities of the movable subject, etc., it is likely that the movable subject is located at a non-ideal position before the path planning. In this case, if a starting node of the path planning is improper, the path planning for the movable subject will fail or the movable subject needs to move along the non-fixed paths for a long time or a long distance, which leads to risks or problems (e.g., the collisions, the congestion, the management difficulties, etc.).

Therefore, it is desirable to provide systems and methods for determining target starting nodes in the path planning, which can improve the success ratio of the path planning and reduce a time or distance that the movable subject moves along the non-fixed paths, thereby reducing the risks, solving the problems, and improving the efficiency of the path planning.

### SUMMARY

An aspect of the present disclosure provides a method for path planning. The method may be implemented on a computing device having at least one processor and at least one storage device. The method may include obtaining posture information of a moveable subject and a path map, the moveable subject being located at a current position in the path map and planning to go to a target position in the path map, the path map including path nodes and path segments, and each of the path segments connecting two path nodes of the path node. The method may include determining, based on the posture information of the moveable subject, one or more target path segments from the path segments in the path map, wherein a first travel cost from the current position of the moveable subject to each of the one or more target path segments satisfying a first condition. The method may also include determining one or more candidate starting nodes based on the one or more target path segments. The method may further include determining a target starting node from the one or more candidate starting nodes, a second travel cost from the target starting node to the target position satisfying a second condition.

Another aspect of the present disclosure provides a system for path planning. The system may include at least one storage device including a set of instructions; and at least one processor configured to communicate with the at least one storage device. When executing the set of instructions, the at least one processor may be configured to direct the system to perform operations. The operations may include obtaining posture information of a moveable subject and a path map, the moveable subject being located at a current position in the path map and planning to go to a target position in the path map, the path map including path nodes and path segments, and each of the path segments connecting two path nodes of the path node. The operations may include determining, based on the posture information of the moveable subject, one or more target path segments from the path segments in the path map, wherein a first travel cost from the current position of the moveable subject to each of the one or more target path segments satisfying a first condition. The operations may also include determining one or more candidate starting nodes based on the one or more target path segments. The operations may further include determining a target starting node from the one or more candidate starting nodes, a second travel cost from the target starting node to the target position satisfying a second condition.

Still another aspect of the present disclosure provides a non-transitory computer readable medium, comprising executable instructions that, when executed by at least one processor, direct the at least one processor to perform a method. The method may include obtaining posture information of a moveable subject and a path map, the moveable subject being located at a current position in the path map and planning to go to a target position in the path map, the path map including path nodes and path segments, and each of the path segments connecting two path nodes of the path node. The method may include determining, based on the posture information of the moveable subject, one or more target path segments from the path segments in the path map, wherein a first travel cost from the current position of the moveable subject to each of the one or more target path segments satisfying a first condition. The method may also include determining one or more candidate starting nodes based on the one or more target path segments. The method may further include determining a target starting node from the one or more candidate starting nodes, a second travel cost from the target starting node to the target position satisfying a second condition.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary path planning system according to some embodiments of the present disclosure;

FIG. 2 is a block diagram illustrating an exemplary processing device according to some embodiments of the present disclosure;

FIG. 3 is a flowchart illustrating an exemplary process for determining a target starting node according to some embodiments of the present disclosure;

FIGS. 4A-4C are schematic diagrams illustrating exemplary path segments according to some embodiments of the present disclosure;

FIG. 5 is a schematic diagram illustrating an exemplary process for determining one or more candidate path segments according to some embodiments of the present disclosure;

FIG. 6 is a schematic diagram illustrating an exemplary second node set according to some embodiments of the present disclosure;

FIG. 7 is a flowchart illustrating an exemplary process for determining a first travel cost of a path segment according to some embodiments of the present disclosure;

FIG. 8A is a schematic diagram illustrating an exemplary first position relationship between a current position and a path segment according to some embodiments of the present disclosure;

FIG. 8B is a schematic diagram illustrating an exemplary second position relationship between a current position and a path segment according to some embodiments of the present disclosure;

FIG. 9A is a schematic diagram illustrating an exemplary third position relationship between a current position and a path segment according to some embodiments of the present disclosure;

FIG. 9B is a schematic diagram illustrating an exemplary fourth position relationship between a current position and a path segment according to some embodiments of the present disclosure;

FIGS. 10A-10E are schematic diagrams illustrating exemplary angles between an orientation of a moveable subject and an orientation of a path segment according to some embodiments of the present disclosure;

FIG. 11 is a schematic diagram illustrating an exemplary process for determining a target start node from multiple candidate starting nodes according to some embodiments of the present disclosure;

FIG. 12 is a schematic diagram illustrating an exemplary electronic device according to some embodiments of the present disclosure; and

FIG. 13 is a schematic diagram illustrating an exemplary computer-readable storage medium according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

It should be noted that the embodiments of the present disclosure relates to data regarding posture information, path maps, etc. When the embodiments of the present disclosure are applied to specific products or techniques, users' permission or consent should be obtained, and collection, use, and processing of the data shall comply with the relevant laws, regulations, and standards of relevant countries and regions.

In order to reduce or solve above problems, the present disclosure relates to systems and methods for path planning. The methods may include obtaining posture information of a moveable subject and a path map. The moveable subject may be located at a current position in the path map and plan to go to a target position in the path map. The path map may include path nodes and path segments, and each of the path segments may connect two path nodes of the path nodes. The methods may include determining, based on the posture information of the moveable subject, one or more target path segments from the path segments in the path map. A first travel cost from the current position of the moveable subject to each of the one or more target path segments may satisfy a first condition. The methods may also include determining one or more candidate starting nodes based on the one or more target path segments. The methods may further include determining a target starting node from the one or more candidate starting nodes. A second travel cost from the target starting node to the target position may satisfy a second condition.

By introducing the travel costs (e.g., the first condition, the second condition, etc.) and the conditions (e.g., the first condition, the second condition, etc.), the target starting node can be determined from the one or more candidate starting nodes, which can reduce a time or distance that the moveable subject moves along non-fixed paths (e.g., parts other than the path nodes and the path segments) in the path map, thereby improving the accuracy of the path planning and reducing or solving the risks (e.g., collisions, congestion, management difficulties, etc.) during a process of directing the moveable subject to move from the current position to the target starting node. In addition, multiple candidate starting nodes can be provided to provide more choices when determining the target starting node, which can improve the success ratio of the determination of the target starting node and the efficiency of the path planning. For example, another candidate starting node can be provided when a current candidate starting node is improper.

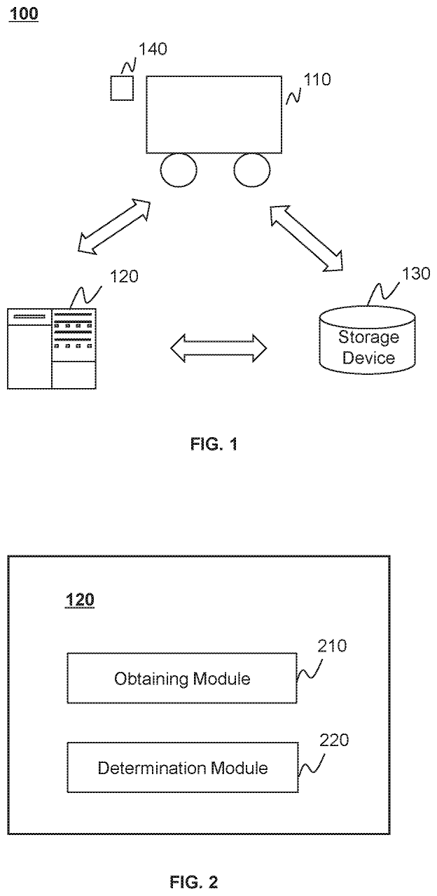

FIG. 1 is a schematic diagram illustrating an exemplary path planning system 100 according to some embodiments of the present disclosure. As shown in FIG. 1, the path planning system 100 may include a moveable subject 110, a processing device 120, and a storage device 130. In some embodiments, the moveable subject 110, the processing device 120, and/or the storage device 130 may be connected to and/or communicate with each other via a wireless connection (e.g., a network), a wired connection, or a combination thereof. The connection between the components in the path planning system 100 may be variable. Merely by way of example, the moveable subject 110 may be connected to the processing device 120 directly as illustrated in FIG. 1 or through a network. As another example, the storage device 130 may be connected to the processing device 120 directly as illustrated in FIG. 1 or through a network.

The moveable subject 110 may move in a preset scenario. For example, the moveable subject 110 may move in the preset scenario based on a path map corresponding to the preset scenario. In some embodiments, the moveable subject 110 may be a movable device.

Exemplary movable devices may include an automated guided vehicle (AGV), a mobile robot, a travel tool, a transport vehicle, a railway vehicle, a driverless vehicle, or the like, or any combination thereof. In some embodiments, the movable device includes a moving part that enables the movable device to move (e.g., wheels), a driving part that drives the moving part (e.g., a motor), a control part that controls the driving part and communicates with the processing device 120, etc. In some embodiments, the movable device is a device with autonomous driving functions or semi-autonomous driving functions. It should be noted that one moveable subject 110 is merely provided for illustration, and not intended to limit the scope of the present disclosure. For example, the path planning system 100 may include a plurality of moveable subjects 110.

The processing device 120 may process data and/or information obtained from one or more components (the moveable subject 110 and/or the storage device 130) of the path planning system 100. For example, the processing device 120 may obtain posture information of the moveable subject 110 and the path map. As another example, the processing device 120 may determine, based on the posture information of the moveable subject, one or more target path segments from the path segments in the path map. A first travel cost from the current position of the moveable subject to each of the one or more target path segments may satisfy a first condition. As still another example, the processing device 120 may determine one or more candidate starting nodes based on the one or more target path segments. As yet another example, the processing device 120 may determine a target starting node from the one or more candidate starting nodes. A second travel cost from the target starting node to the target position may satisfy a second condition.

In some embodiments, the processing device 120 may be a single server or a server group. The server group may be centralized or distributed. In some embodiments, the processing device 120 may be local or remote. For example, the processing device 120 may access information and/or data stored in the moveable subject 110 and/or the storage device 130.

In some embodiments, the processing device 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing device 120 may be a cloud server that can be used to provide cloud services, cloud databases, cloud computing, cloud functions, cloud storage, network services, cloud communications, middleware services, domain name services, security services, content delivery network (CDN), basic cloud computing services (e.g., big data, artificial intelligence platforms, etc.), etc. In some embodiments, the processing device 120 may be part of the moveable subject 110.

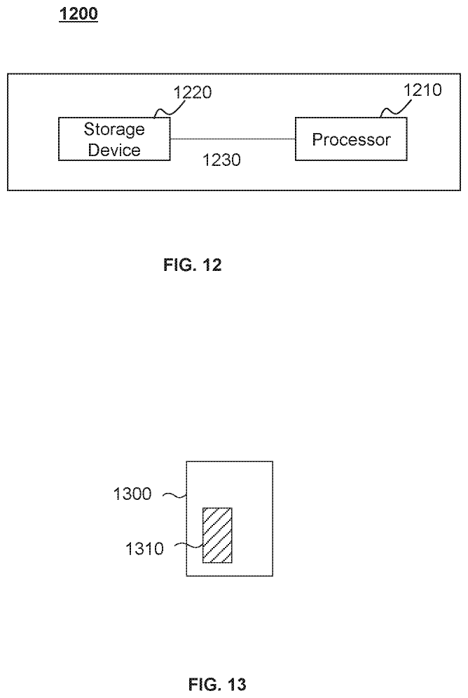

In some embodiments, the processing device 120 may be implemented by a computing device (e.g., an electronic device 1200 as shown in FIG. 12). For example, the computing device may include a processor, a storage, an input/output (I/O), and a communication port. The processor may execute computer instructions (e.g., program codes) and perform functions of the processing device 120 in accordance with the techniques described herein. The computer instructions may include, for example, routines, programs, objects, components, data structures, procedures, modules, and functions, which perform particular functions described herein.

The storage device 130 may store data/information obtained from the moveable subject 110 and/or any other component of the path planning system 100. In some embodiments, the storage device 130 may include a mass storage, a removable storage, a volatile read-and-write memory, a read-only memory (ROM), or the like, or any combination thereof. For example, the mass storage may include a magnetic disk, an optical disk, a solid-state drive, etc. The removable storage may include a flash drive, a floppy disk, an optical disk, a memory card, a zip disk, a magnetic tape, etc. In some embodiments, the storage device 130 may store one or more programs and/or instructions to perform exemplary methods described in the present disclosure.

In some embodiments, the storage device 130 may be communicated with one or more other components (e.g., the moveable subject 110, the processing device 120) in the path planning system 100. One or more components in the path planning system 100 may access the data or instructions stored in the storage device 130. In some embodiments, the storage device 130 may be part of the processing device 120.

In some embodiments, the path planning system 100 may further include at least one positioning device 140. The at least one positioning device 140 may be configured to capture the posture information of the moveable subject 110. For example, the at least one positioning device 140 may include an image acquisition device (or a device based on a simultaneous localization and mapping (SLAM) technique), a device based on a global positioning system (GPS), a device based on a global navigation satellite system (GLONASS), a device based on a compass navigation system (COMPASS), a device based on a BeiDou navigation satellite system, a device based on a Galileo positioning system, a device based on a quasi-zenith satellite system (QZSS), a device based on a wireless fidelity (Wi-Fi) positioning technique, a device based on a wireless carrier positioning technique, a device based on a Bluetooth positioning technique, a device based on a radio frequency identification (RFID) technique, or the like, or any combination thereof. Exemplary image acquisition devices may include a camera, an optical sensor, a radar sensor, a structured light scanner, or the like, or any combination thereof.

In some embodiments, the at least one positioning device 140 may be mounted on the moveable subject 110 through a detachable or non-detachable connection. For example, the at least one positioning device 140 may be detachably mounted on the moveable subject 110. As another example, the at least one positioning device 140 may be part of the moveable subject 110.

In some embodiments, the at least one positioning device 140 may be mounted at a location other than the moveable subject 110 through a detachable or non-detachable connection. For example, the at least one positioning device 140 may be disposed at one or more locations in the preset scenario.

In some embodiments, the path planning system 100 may further include a network and/or at least one terminal. The network may facilitate the exchange of information and/or data for the path planning system 100. In some embodiments, one or more components (e.g., the moveable subject 110, the processing device 120, the storage device 130, the at least one positioning device 140) of the path planning system 100 may transmit information and/or data to other component(s) of the path planning system 100 via the network. In some embodiments, the network may be any type of wired or wireless network, or combination thereof.

The at least one terminal may be configured to receive information and/or data from the moveable subject 110, the processing device 120, the storage device 130, and/or the at least one positioning device 140, such as, via the network. For example, the at least one terminal may receive the target starting node from the processing device 120. In some embodiments, the at least one terminal may process information and/or data received from the moveable subject 110, the processing device 120, the storage device 130, and/or the at least one positioning device 140. In some embodiments, the at least one terminal may provide a user interface via which a user may view information and/or input data and/or instructions to the path planning system 100. In some embodiments, the at least one terminal may include a mobile phone, a computer, a wearable device, or the like, or any combination thereof. In some embodiments, the at least one terminal may include a display that can display information in a human-readable form, such as text, image, audio, video, graph, animation, or the like, or any combination thereof. The display of the at least one terminal may include a cathode ray tube (CRT) display, a liquid crystal display (LCD), a light-emitting diode (LED) display, a plasma display panel (PDP), a three-dimensional (3D) display, or the like, or a combination thereof.

It should be noted that the above description is merely provided for the purposes of illustration, and is not intended to limit the scope of the present disclosure. For persons having ordinary skills in the art, multiple variations and modifications may be made under the teachings of the present disclosure. Features, structures, methods, and other characteristics of the exemplary embodiments described herein may be combined in various ways to obtain additional and/or alternative exemplary embodiments. However, those variations and modifications do not depart from the scope of the present disclosure.

FIG. 2 is a block diagram illustrating an exemplary processing device 120 according to some embodiments of the present disclosure. In some embodiments, the processing device 120 may be in communication with a computer-readable storage medium (e.g., the storage device 130 illustrated in FIG. 1) and may execute instructions stored in the computer-readable storage medium. The processing device 120 may include an obtaining module 210 and a determination module 220.

The obtaining module 210 may be configured to obtain posture information of a moveable subject (e.g., the moveable subject 110) and a path map. The moveable subject may be located at a current position in the path map and plan to go to a target position in the path map. The path map may include path nodes and path segments, and each of the path segments may connect two path nodes of the path nodes. More descriptions regarding the obtaining the posture information of the moveable subject and the path map may be found elsewhere in the present disclosure. See, e.g., operation 302 and relevant descriptions thereof.

The determination module 220 may be configured to determine, based on the posture information of the moveable subject, one or more target path segments from the path segments in the path map. A first travel cost from the current position of the moveable subject to each of the one or more target path segments may satisfy a first condition. More descriptions regarding the determination of the one or more target path segments may be found elsewhere in the present disclosure. See, e.g., operation 304 and relevant descriptions thereof.

In some embodiments, the determination module 220 may be also configured to determine one or more candidate starting nodes based on the one or more target path segments. More descriptions regarding the determination of the one or more candidate starting nodes may be found elsewhere in the present disclosure. See, e.g., operation 306 and relevant descriptions thereof.

In some embodiments, the determination module 220 may be further configured to determine a target starting node from the one or more candidate starting nodes. A second travel cost from the target starting node to the target position may satisfy a second condition. More descriptions regarding the determination of the target starting node may be found elsewhere in the present disclosure. See, e.g., operation 308 and relevant descriptions thereof.

It should be noted that the above descriptions of the processing device 120 are provided for the purposes of illustration, and not intended to limit the scope of the present disclosure. For persons having ordinary skills in the art, various variations and modifications may be conducted under the guidance of the present disclosure. However, those variations and modifications do not depart from the scope of the present disclosure. In some embodiments, the processing device 120 may include one or more other modules. For example, the processing device 120 may include a storage module to store data generated by the modules in the processing device 120. In some embodiments, any two of the modules may be combined as a single module, and any one of the modules may be divided into two or more units. For example, the determination module 220 may include a first determination unit, a second determination unit, and a third determination unit, wherein the first determination unit may be configured to determine the one or more target path segments from the path segments in the path map based on the posture information of the moveable subject, the second determination unit may be configured to determine the one or more candidate starting nodes based on the one or more target path segments, and the third determination unit may be configured to determine the target starting node from the one or more candidate starting nodes.

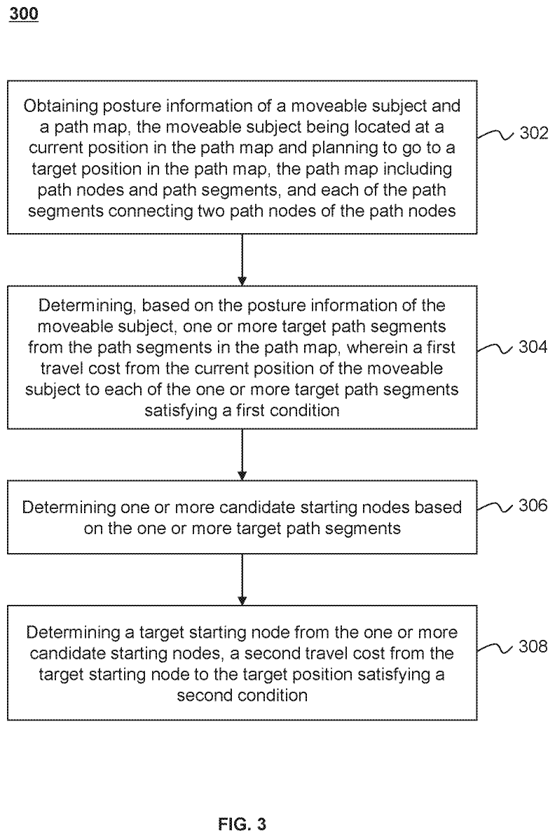

FIG. 3 is a flowchart illustrating an exemplary process 300 for determining a target starting node according to some embodiments of the present disclosure.

In 302, the processing device 120 (e.g., the obtaining module 210) may obtain posture information of a moveable subject and a path map.

The moveable subject may be located in a preset scenario corresponding to the path map, wherein path planning needs to be performed for the moveable subject. In some embodiments, the moveable subject (e.g., the moveable subject 110) may be a movable device (e.g., an AGV). More descriptions regarding the moveable subject may be found elsewhere in the present disclosure (e.g., FIG. 1 and the descriptions thereof).

The moveable subject may be located at a current position in the path map and plan to go to a target position in the path map. The current position refers to a position where the moveable subject is currently located in the preset scenario, and the target position refers to a position where the moveable subject plans to go in the preset scenario. In some embodiments, the current position of the moveable subject may be determined through a positioning technique.

Exemplary positioning techniques may include an SLAM technique, a GPS technique, a GLONASS technique, a COMPASS technique, a Wi-Fi positioning technique, a wireless carrier positioning technique, a Bluetooth positioning technique, an RFID technique, or the like, or any combination thereof. The target position of the moveable subject may be determined based on a moving plan. For example, a user may pre-determine the moving plan for the moveable subject, and the processing device 120 may determine the target position based on the moving plan. In some embodiments, the target position may be set by the user. In some embodiments, the current position and the target position may be represented by position coordinates in the path map.

The posture information of the moveable subject may include position information and orientation (or pose) information of the moveable subject in a preset coordinate system. The preset coordinate system refers to a reference coordinate system used to define the posture information. For example, the preset coordinate system may include a world coordinate system, a coordinate system corresponding to a positioning device (e.g., one of the at least one positioning device 140), a coordinate system corresponding to the moveable subject, or the like, or any combination thereof. In some embodiments, the preset coordinate system may be pre-determined based on a system default setting, or set manually by a user.

In some embodiments, the posture information of the moveable subject may include a plurality of degrees of freedom (DOFs) (or referred to as dimensions), wherein a portion of the plurality of DOFs correspond to the position information, and the other DOFs of the plurality of DOFs correspond to the orientation information. For example, the posture information of the moveable subject may include three translational DOFs (i.e., X, Y, Z coordinates in the preset coordinate system) corresponding to the position information and three rotational DOFs (i.e., a roll angle, a pitch angle, and a yaw angle corresponding to X, Y, Z axes in the preset coordinate system) corresponding to the orientation information.

In some embodiments, the posture information of the moveable subject may indicate a relative posture with respect to reference subject(s). For example, a reference subject may be pre-determined, and the posture information of the moveable subject may be represented as a position relative to the reference subject, an angle relative to the reference subject, etc.

In some embodiments, the processing device 120 may obtain the posture information of the moveable subject from a positioning device (e.g., the at least one positioning device 140). For example, an image acquisition device may be mounted on the moveable subject and obtain image data by scanning the preset scenario. The image acquisition device may obtain the posture information of the moveable subject based on the image data, and send the posture information to the processing device 120. Alternatively, the processing device 120 may obtain the image data from the image acquisition device, and determine the posture information of the moveable subject based on the image data. As another example, an image acquisition device may be mounted in the preset scenario and obtain image data of the moveable subject. The processing device 120 may obtain the posture information of the moveable subject based on the image data. It should be noted that the image acquisition device is merely provided for illustration, and not intended to limit the scope of the present disclosure. In some embodiments, the processing device 120 may obtain the posture information of the moveable subject from a storage device (e.g., the storage device 130, an external storage device, etc.) that stores the posture information.

The path map refers to a map illustrating recommended paths for the moveable subject to move along in the preset scenario. In some embodiments, the path map may be used to guide the moveable subject to move along the paths in the preset scenario. For example, the moveable subject may move along the paths in the preset scenario based on the path map. Exemplary path maps may include a topology map, a metric map (e.g., a raster map, a feature map, a point-cloud map, etc.), a semantic map, or the like, or any combination thereof. Merely by way of example, the path map may be a topology map including path nodes and path segments, and each of the path segments may connect two path nodes of the path nodes. Remaining parts of the path map (parts other than the path nodes and the path segments) refer to non-fixed paths that are prone to occur risks (e.g., the collisions, the congestion, the management difficulties, etc.) and less recommended to the moveable subject. For example, as illustrated in FIG. 5, black straight lines represent path segments, intersection points of the black straight lines represent path nodes, and white regions represent non-fixed paths.

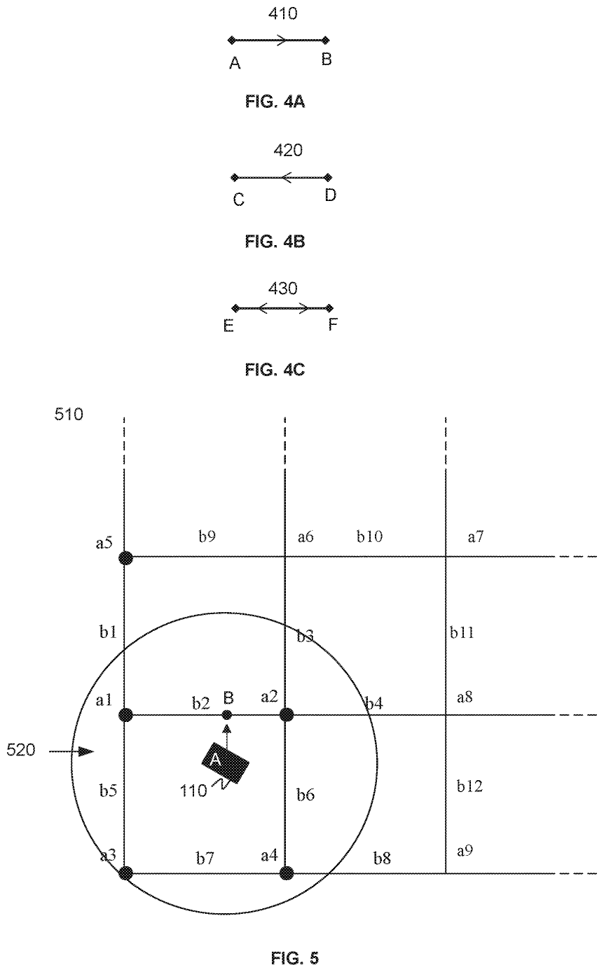

In some embodiments, each path segment may include an orientation. The orientation of a path segment refers to a connection direction of two path nodes connecting by the path segment. For example, for a path segment that connects a first path node and a second path node, exemplary orientations of the path segment may include unidirection from the first path node to the second path node, unidirection from the second path node to the first path node, and bidirection (i.e., including both the direction from the first path node to the second path node and the direction from the second path node to the first path node). Referring to FIGS. 4A-4C, FIGS. 4A-4C are schematic diagrams illustrating exemplary path segments according to some embodiments of the present disclosure. As shown in FIG. 4A, a path segment 410 connects a path node A and a path node B, and the path segment 410 is unidirectional from the path node A to the path node B. As shown in FIG. 4B, a path segment 420 connects a path node C and a path node D, and the path segment 420 is unidirectional from the path node D to the path node C. As shown in FIG. 4C, a path segment 430 connects a path node E and a path node F, and the path segment 430 is bidirectional.

In some embodiments, the processing device 120 may obtain the path map from a storage device (e.g., the storage device 130, an external storage device, etc.) that stores the path map. For example, the path map may be pre-established based on the preset scenario and stored in the storage device 130. The processing device 120 may obtain the path map by retrieving the path map from the storage device 130. In some embodiments, the path map may include one or more labels. For example, the one or more labels may include a scenario name, a type of the moveable subject, a serial number, or the like, or any combination thereof. Merely by way of example, the storage device 130 may store a plurality of candidate path maps, and each of the plurality of candidate path maps may include at least one label. The processing device 120 may retrieve the path map from the plurality of candidate path map based on at least one target label.

In some embodiments, the processing device 120 may update the path map based on the posture information of the moveable subject and the target position. For example, the processing device 120 may determine the current position of the moveable subject in the path map based on the posture information of the moveable subject, and generate an updated path map by removing a portion of the path map based on the current position and the target position. Merely by way of example, the path map may include a plurality of regions, the processing device 120 may generate the updated path map by removing regions that do not satisfy a fourth condition from the plurality of regions. The fourth condition may include a first distance between the region and the current position being less than a first distance threshold, a second distance between the region and the target position being less than a second distance threshold, or the region being located between the current position and the target position. The first distance threshold and the second distance threshold may be determined based on a system default setting, or set manually by the user. In some embodiments, the first distance threshold may be the same as or different from the second distance threshold.

By updating the path map, a portion of the path map can be removed, and counts of the path nodes and path segments in the updated path map can be reduced, which can reduce subsequent processing workloads, thereby improving the efficiency of the determination of the target starting node and the path planning.

For purposes of illustration, the path map is taken as an example in the following descriptions to describe the implementation of the process 300.

In 304, the processing device 120 (e.g., the determination module 220) may determine, based on the posture information of the moveable subject, one or more target path segments from the path segments in the path map. A first travel cost from the current position of the moveable subject to each of the one or more target path segments may satisfy a first condition.

A target path segment refers to a path segment that is selected from the path map and suitable for the moveable subject to move to.

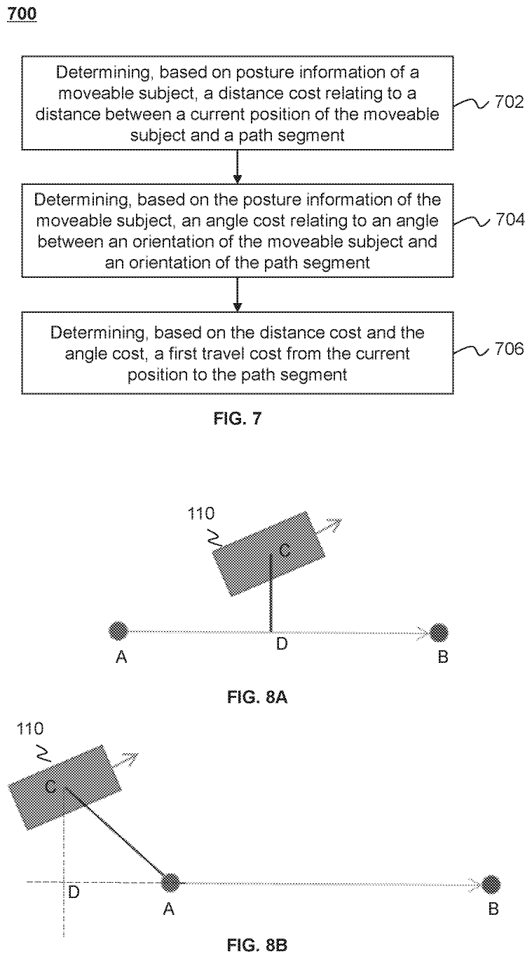

A first travel cost of a path segment is used to measure the amount of moving resources consumed by moving the moveable subject from the current position to the path segment. Exemplary moving resources may include a moving time, a moving distance, a moving energy, or the like, or any combination thereof. In some embodiments, the first travel cost of the path segment may include a distance cost relating to a distance between the current position and the path segment, an angle cost relating to an angle between an orientation of the moveable subject and an orientation of the path segment, etc. More descriptions regarding the determination of the first travel cost of the path segment may be found elsewhere in the present disclosure (e.g., FIGS. 7-10E and the descriptions thereof).

The first condition may include that the first travel cost of the path segment being less than or equal to a first travel cost threshold. A type of the first travel cost threshold may be the same as a type of the first travel cost. For example, if the first travel cost is represented by the distance cost, the first travel cost threshold may be represented by the distance cost, such as, 5 meters, 10 meters, 15 meters, 20 meters, etc. In some embodiments, if the first travel cost includes multiple types of travel cost, the first travel cost threshold may also include multiple thresholds corresponding to the multiple types of travel cost. In some embodiments, the first travel cost threshold may be determined based on a system default setting or an empirical value, or set manually by the user.

In some embodiments, the processing device 120 may determine a path node range in the path map based on the posture information of the moveable subject. For example, the processing device 120 may determine a reference point on the moveable subject as a central point of the path node range based on the posture information of the moveable subject, and determine a radius of the path node range. Exemplary reference point may include a center of gravity of the moveable subject, a center of mass of the moveable subject, a center of a front surface of the moveable subject, a center of a rear surface of the moveable subject, a vertex of the moveable subject, or the like, or any combination thereof. In some embodiments, the radius of the path node range may be determined based on relevant information regarding the path planning. For example, the relevant information may include a size of the moveable subject, an area of the path map, counts of the path nodes and path segments in the path map, a processing capacity of the processing device 120, or the like, or any combination thereof. For instance, the processing device 120 may determine the radius of the path node range as 2 meters based on the size of the moveable subject of 1 meter. In some embodiments, the radius of the path node range may be determined based on a system default setting or an empirical value, or set manually by the user. It should be noted that a circular path node range is merely provided for illustration, and not intended to limit the scope of the present disclosure. For example, the shape of the path node range may be an irregular shape or another regular shape (e.g., an ellipse, a square, a rectangle, a triangle, etc.).

In some embodiments, the processing device 120 may determine one or more candidate path segments from the path segments. Each of the one or more candidate path segments may include at least one path node within the path node range. In some embodiments, the at least one path node within the path node range may form a first node set. That is, each of the at least one path node within the path node range may be a member of the first node set.

Referring to FIG. 5, FIG. 5 is a schematic diagram illustrating an exemplary process for determining one or more candidate path segments according to some embodiments of the present disclosure. As shown in FIG. 5, a path map 510 includes path nodes (e.g., path nodes a1, a2, a3, a4, a5, a6, a7, a8, and a9) and path segments (e.g., path segments b1, b2, b3, b4, b5, b6, b7, b8, b9, b10, b11, and b12). The path nodes a1, a2, a3, and a4 are within a range 520 (e.g., the path node range), the path nodes a1 connects the path segments b1, b2, and b5, the path nodes a2 connects the path segments b2, b3, b4, and b6, the path nodes a3 connects the path segments b5 and b7, and the path nodes a4 connects the path segments b6, b7, and b8. In such cases, the path nodes a1, a2, a3, and a4 form the first node set, and the path segments b1, b2, b3, b4, b5, b6, b7, and b8 each of which includes at least one of the first node set are determined as candidate path segments.

By determining the one or more candidate path segments from the path segments through the path node range, a portion of the path segments can be filtered, and a count of path segments that need subsequent operations can be reduced, which can reduce subsequent processing workloads, thereby improving the efficiency of the determination of the target starting node and the path planning.

In some embodiments, the processing device 120 may select the one or more target path segments from the one or more candidate path segments. For example, the processing device 120 may select the one or more target path segments from the one or more candidate path segments based on a first travel cost of each of the one or more candidate path segments. Merely by way of example, for each of the one or more candidate path segments, the processing device 120 may determine the first travel cost from the current position to the candidate path segment based on the posture information of the moveable subject, and then determine whether the first travel cost of the candidate path segment satisfies the first condition. In response to determining that the first travel cost of the candidate path segment satisfies the first condition, the processing device 120 may designate the candidate path segment as one of the one or more target path segments. Otherwise, the processing device 120 may determine that the candidate path segment is not a target path segment.

In some embodiments, the processing device 120 may select the one or more target path segments from the one or more candidate path segments further based on a third travel cost corresponding to each of the one or more candidate path segments. A third travel cost corresponding to a candidate path segment is used to measure the amount of moving resources consumed by moving the moveable subject from the current position to each path node in the candidate path segment. In some embodiments, for a candidate path segment connecting a first path node and a second path node, the third travel cost corresponding to the candidate path segment may be include a third travel cost from the current position to the first path node and a third travel cost from the current position to the second path node. The third travel cost from the current position to the first path node may include a third distance cost relating to a distance between the current position and the first path node, a third angle cost relating to an angle between the orientation of the moveable subject and an orientation of the candidate path segment, etc.

In some embodiments, the processing device 120 may determine whether the third travel cost from the current position to each path node in the candidate path segment satisfies a third condition. The third condition may include the third travel cost of the candidate path segment being less than or equal to a third travel cost threshold. The third travel cost threshold may be determined in a similar manner as how the first travel cost threshold is determined, which is not repeated herein. In some embodiments, the third travel cost threshold may be the same as or different from the first travel cost threshold. In response to determining that the first travel cost of the candidate path segment satisfies the first condition and the third travel cost from the current position to each path node in the candidate path segment satisfies the third condition, the processing device 120 may designate the candidate path segment as one of the one or more target path segments.

In some embodiments, the processing device 120 may select the one or more target path segments from the one or more candidate path segments further based on a sixth travel cost of each of the one or more candidate path segments. A sixth travel cost of a candidate path segment is used to measure the amount of minimum moving resources consumed by moving the moveable subject to the candidate path segment or a path segment connecting one path node in the candidate path segment. In some embodiments, for a candidate path segment connecting a first path node and a second path node, the sixth travel cost of the candidate path segment may be equal to a minimum travel cost of first travel costs of path segments connecting the first path node and the second path node. For example, continuing to refer to FIG. 5, the path segment b2 connects the path nodes a1 and a2, the path node a1 connects the path segments b1, b2, and b5, and the path node a2 connects the path segments b2, b3, b4, and b6. A sixth travel cost of the path segment b2 is a minimum travel cost of the first travel costs of the path segments b1, b2, b3, b4, b5, and b6.

In some embodiments, the processing device 120 may determine whether the sixth travel cost of each of the one or more candidate path segments satisfies a fifth condition. The fifth condition may include the sixth travel cost of the candidate path segment being less than or equal to a fourth travel cost threshold. The fourth travel cost threshold may be determined in a similar manner as how the first travel cost threshold is determined, which is not repeated herein. In some embodiments, the fourth travel cost threshold may be the same as or different from the first travel cost threshold. In response to determining that the first travel cost of the candidate path segment satisfies the first condition and the sixth travel cost of the candidate path segment satisfies the fifth condition, the processing device 120 may designate the candidate path segment as one of the one or more target path segments.

In some embodiments, the processing device 120 may generate a second node set by filtering the first node set based on the third travel cost. A count of path nodes in the second node set may be less than a count of path nodes in the first node set. The count of path nodes in the second node set (also referred to as a preset count) may be preset based on a system default setting or an empirical value, or set manually by the user. For example, the processing device 120 may determine the third travel cost of each of the at least one path node within the path node range, and determine a second node sequence by sorting the at least one path node based on the third travel costs. Further, the processing device 120 may generate the second node set based on the preset count and the second node sequence. As another example, the processing device 120 may determine the third travel cost of each of the at least one path node within the path node range in sequence, and add path node(s) that satisfy the third condition into an initial second node set until a count of members in the second node set is equal to the preset count. Then, the processing device 120 may update the initial second node set by replacing a path node in the second node set having a maximum third travel cost based on third travel costs of remaining of the at least one path node. When all path nodes in the first node set are processed, the processing device 120 may designate the updated second node set as the second node set.

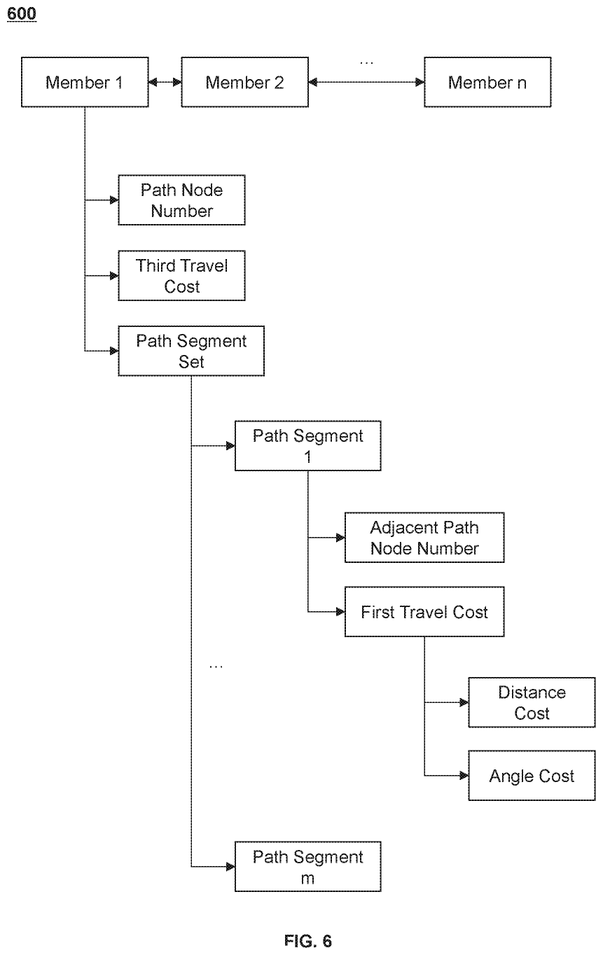

Merely by way of example, referring to FIG. 6, FIG. 6 is a schematic diagram illustrating an exemplary second node set 600 according to some embodiments of the present disclosure. As illustrated in FIG. 6, the second node set 600 includes n path nodes (i.e., member 1, member 2, . . . , member n). Each of the n path nodes includes first information regarding path node number, a third travel cost, and a path segment set. The path segment set includes path segments connecting the path node, and each of the path segments may include second information regarding an adjacent path node number and a first travel cost including a distance cost and an angle cost. Referring to FIGS. 5 and 6, if the path node a1 is a member of the second node set 600, first information of the path node a1 may include a path node number a1, a third travel cost of a1 (e.g., a minimum travel cost among first travel costs of the path segments b1, b2, and b5), and a path segment set including the path segments b1, b2, and b5. Second information of the path segment b1 may include an adjacent path node number a5 and a first travel cost of the path segment b1 (including a distance cost relating to a distance between the current position of the moveable subject 110 and the path segment b1 and an angle cost relating to an angle between an orientation of the moveable subject 110 and an orientation of the path segment b1).

In some embodiments, the processing device 120 may remove repeated path segment(s) in the second node. For example, referring to FIG. 5 again, if the second node set includes the path nodes a1 and a2, information relating to the path nodes a1 and a2 may include the path segment b2. Therefore, the processing device 120 may remove the path segment b2 from the information relating to the path node a2. By removing repeated path segment(s) from the information relating to the second node, a processing volume can be decreased, which can improve the efficiency of the determination of the target starting node and the path planning.

In some embodiments, due to the orientation of each path segment, a portion of the path nodes in the path map may have no accessible path to the target position. That is, the moveable subject can not move to the target position from each of the portion of the path nodes. In some embodiments, the processing device 120 may select one or more path nodes from the path nodes in the path map. Each selected path node may have no accessible path to the target position. The processing device 120 may obtain a filtered path map by removing the one or more selected path nodes from the path map, and determine the one or more target path segments from the path segments in the filtered path map based on the posture information of the moveable subject. The determination of the one or more target path segments from the path segments in the filtered path map based on the posture information of the moveable subject may be performed in a similar manner to the determination of the one or more target path segments from the path segments in the path map based on the posture information of the moveable subject, which is not repeated herein.

By removing the one or more selected path nodes from the path map, path node(s) having no accessible path to the target position can be filtered, which can reduce subsequent processing workloads and improve the success ratio of the path planning, thereby improving the efficiency of the determination of the target starting node and the path planning.

In some embodiments, the processing device 120 may determine a path segment range in the path map based on the posture information of the moveable subject, and determine the one or more candidate path segments from the path segments based on the path segment range. Further, the processing device 120 may select the one or more target path segments from the one or more candidate path segments. The path segment range may be determined in a similar manner as how the path node range is determined, which is not repeated herein. In some embodiments, the processing device 120 may determine the one or more candidate path segments from the path segments based on the path segment range. For example, if a portion of a path segment is within the path segment range, the processing device 120 may determine the path segment as one of the one or more candidate path segments. Merely by way of example, as shown in FIG. 5, since at least a portion of each of the path segments b1, b2, b3, b4, b5, b6, b7, and b8 are within the range 520 (e.g., the path segment range), the path segments b1, b2, b3, b4, b5, b6, b7, and b8 are determined as candidate path segments.

By determining the one or more candidate path segments from the path segments through the path segment range, a portion of the path segments can be filtered, and a count of path segments that need subsequent operations can be reduced, which can reduce subsequent processing workloads, thereby improving the efficiency of the determination of the target starting node and the path planning.

In 306, the processing device 120 (e.g., the determination module 220) may determine one or more candidate starting nodes based on the one or more target path segments.

A candidate starting node refers to a path node that is likely to be determined as a target starting node.

For example, the processing device 120 may determine path nodes of each of the one or more target path segments as the candidate starting node(s).

As another example, for each of the one or more target path segments, the processing device 120 may determine a path node of the target path segment with a smaller third travel cost as one of the candidate starting node(s). For instance, if the moveable subject is located outside the target path segment, the processing device 120 may determine a path node of the target path segment closer to the moveable subject as one of the candidate starting node(s). As another example, if the moveable subject is located at a path node of the target path segment, the processing device 120 may determine the path node as one of the candidate starting node(s). As still another example, if the moveable subject is located at the target path segment and the target path segment is unidirectional, the processing device 120 may determine a path node to which the target path segment is directed as one of the candidate starting node(s). For instance, if the target path segment is unidirectional from a first path node to a second path node, the second path node of the target path segment may be determined as one of the candidate starting node(s). As still another example, if the moveable subject is located at the target path segment and the target path segment is bidirectional, the processing device 120 may determine a path node with a smaller correction cost as one of the candidate starting node(s). The correction cost of a path node of the target path segment may be determined based on a distance between the path node and the moveable subject. For example, the correction cost of the path node may be equal to a Manhattan distance between the path node and the moveable subject. For instance, the Manhattan distance between the path node and the moveable subject may be determined according to Equation (1):

$${D}_{M} = \vert {x}_{a} - {x}_{b} \vert + \vert {y}_{a} - {y}_{b} \vert , \qquad ( 1 )$$

where D_{M} refers to the Manhattan distance between the path node and the moveable subject; xₐ refers to an abscissa of the path node in the preset coordinate system; x_{b} refers to an abscissa of the moveable subject in the preset coordinate system; yₐ refers to an ordinate of the path node in the preset coordinate system; and y_{b} refers to an ordinate of the moveable subject in the preset coordinate system.

In 308, the processing device 120 (e.g., the determination module 220) may determine a target starting node from the one or more candidate starting nodes. A second travel cost from the target starting node to the target position may satisfy a second condition.

The target starting node refers to a starting node of a planned path to the target position to be determined for the moveable subject.

A second travel cost of a starting node is used to measure the amount of moving resources consumed by moving the moveable subject from the starting node to the target position. In some embodiments, the second travel cost of the starting node may include a second distance cost relating to a distance between the starting node and the target position, a second angle cost relating to an angle between the orientation of the moveable subject and an orientation of a path segment connecting the starting node, a total angle cost relating to rotation angles of the planned path from the starting node to the target position, etc. In some embodiments, when there is no accessible path from the starting node to the target position, the second travel cost of the starting node may be determined to be infinite.

The second condition may include that the second travel cost is less than or equal to a second travel cost threshold. Similar to the first travel cost, the second travel cost may include multiple types of travel cost, and the second travel cost threshold may also include multiple thresholds corresponding to the multiple types of travel cost. In some embodiments, the second travel cost threshold may be determined based on a system default setting or an empirical value, or set manually by the user.

In some embodiments, the one or more candidate starting nodes may include one candidate starting node, and the second travel cost threshold may be set to be infinite. That is, if there is an accessible path from the candidate starting node to the target position, the processing device 120 may designate the candidate starting node as the target starting node.

In some embodiments, the one or more candidate starting nodes may include multiple candidate starting nodes, and the processing device 120 may determine the target starting node from the one or more candidate starting nodes.

For example, the processing device 120 may determine a fourth travel cost from the current position to each candidate starting node, and determine a node sequence by sorting the candidate starting nodes based on the fourth travel costs. Further, the processing device 120 may sequentially process the candidate starting nodes in the node sequence until a second travel cost from the currently processed candidate starting node to the target position satisfies the second condition. A fourth travel cost of a candidate starting node is used to measure the amount of moving resources consumed by moving the moveable subject from the current position to the candidate starting node. In some embodiments, the processing device 120 may determine the fourth travel cost of the candidate starting node based on the first travel cost of the candidate starting node and a fifth travel cost of the candidate starting node. The fifth travel cost of the candidate starting node is used to measure the amount of moving resources consumed by moving the moveable subject from a projection point of the moveable subject on the candidate path segment to the candidate starting node. Referring to FIG. 5, a fourth travel cost of the moveable subject 110 from a current position to a candidate starting node (e.g., the path node a2) includes a first travel cost of the moveable subject 110 from the current position (e.g., a reference point A of the moveable subject 110) to a projection point B of the reference point A along a direction perpendicular to the path segment b2 located at the path segment b2 and a fifth travel cost from the projection point B to the path node a2.

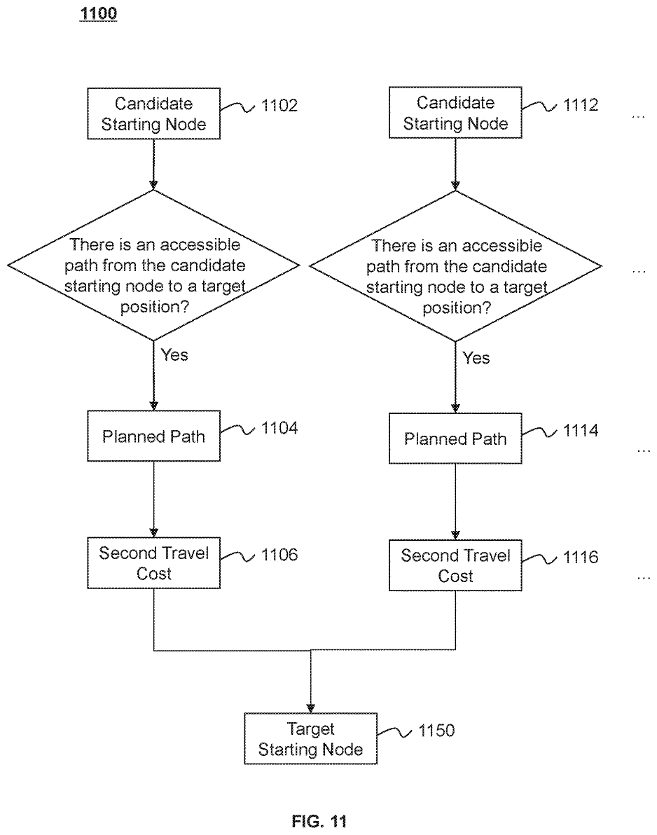

As another example, for each of the multiple candidate starting nodes, the processing device 120 may determine whether there is an accessible path from the candidate starting node to the target position. If there is an accessible path from the candidate starting node to the target position, the processing device 120 may determine a second travel cost from the candidate starting node to the target position based on a planned path from the candidate starting node to the target position based on the path map. Further, the processing device 120 may determine the target starting node from the multiple candidate starting nodes based on the second travel costs of the multiple candidate starting nodes. More descriptions regarding the determination of the target starting node from the multiple candidate starting nodes may be found elsewhere in the present disclosure (e.g., FIG. 11 and the descriptions thereof).

According to some embodiments of the present disclosure, the target starting node can be determined from the one or more candidate starting nodes, and the target starting node satisfies one or more conditions (e.g., the first condition, the second condition, etc.), which can reduce the travel cost (e.g., the first travel cost, the second travel cost, etc.) from the current position of the moveable subject to the target starting node, thereby improving the accuracy of the path planning and reducing or solving the risks (e.g., collisions, congestion, management difficulties, etc.) during a process of directing the moveable subject to move from the current position to the target starting node. In addition, multiple candidate starting nodes can be provided to provide more choices when determining the target starting node, which can improve the success ratio of the determination of the target starting node and the efficiency of the path planning. For example, another candidate starting node can be provided when a current candidate starting node is improper.

FIG. 7 is a flowchart illustrating an exemplary process 700 for determining a first travel cost of a path segment according to some embodiments of the present disclosure. In some embodiments, the process 700 may be performed to achieve at least part of operation 304 as described in connection with FIG. 3.

In 702, the processing device 120 (e.g., the determination module 220) may determine, based on posture information of a moveable subject, a distance cost relating to a distance between a current position of the moveable subject and a path segment.

In some embodiments, the distance between the current position of the moveable subject and the path segment refers to the shortest distance between the current position and the path segment. In some embodiments, the distance between the current position of the moveable subject and the path segment may be a Euclidean distance or any other distance between the current position of the moveable subject and the path segment.

In some embodiments, the processing device 120 may determine a position relationship between the current position and the path segment based on the posture information of the moveable subject, and determine the distance cost based on the position relationship, the posture information, and a path map including the path segment.

The position relationship between the current position and the path segment may include a first position relationship that the moveable subject is located outside the path segment and a projection of the moveable subject (e.g., a projection of a reference point of the moveable subject) along a direction perpendicular to the path segment is located on the path segment (including path nodes connecting by the path segment), a second position relationship that the moveable subject is located outside the path segment and the projection of the moveable subject is located on an extended line of the path segment, a third position relationship that the moveable subject is located on the path segment other than the path nodes, and a fourth position relationship that the moveable subject is located on one of the path nodes. In some embodiments, when a minimum distance (e.g., a projection distance) between the moveable subject and the path segment does not exceed a third distance threshold, the moveable subject may be regarded to be located on the path segment. The third distance threshold may be determined based on a system default setting or an empirical value, or set manually by a user.

For example, referring to FIG. 8A, FIG. 8A is a schematic diagram illustrating an exemplary first position relationship between a current position of a moveable subject and a path segment according to some embodiments of the present disclosure. As shown in FIG. 8A, the moveable subject 110 is located outside a path segment AB, and a projection of a reference point C of the moveable subject 110 along a direction perpendicular to the path segment AB is located at a point D of the path segment AB. A distance cost relating to a distance between a current position of the moveable subject 110 and the path segment AB is equal to a length of a segment CD (i.e., a Euclidean distance between the reference point C and the point D). The distance of the segment CD can be determined based on the posture information of the moveable subject 110 and a path map including the path segment AB.

As another example, referring to FIG. 8B, FIG. 8B is a schematic diagram illustrating an exemplary second position relationship between a current position of a moveable subject and a path segment according to some embodiments of the present disclosure. As shown in FIG. 8B, the moveable subject 110 is located outside a path segment AB, and a projection of a reference point C of the moveable subject 110 along a direction perpendicular to the path segment AB is located at a point D on an extended line of the path segment AB. That is, the projection of the reference point C is located out of the path segment AB. A distance cost relating to a distance between a current position of the moveable subject 110 and the path segment AB is equal to a length of a segment AC (i.e., a Euclidean distance between the reference point C and a path node A). The distance of the segment AC can be determined based on the posture information of the moveable subject 110 and the path map including the path segment AB.

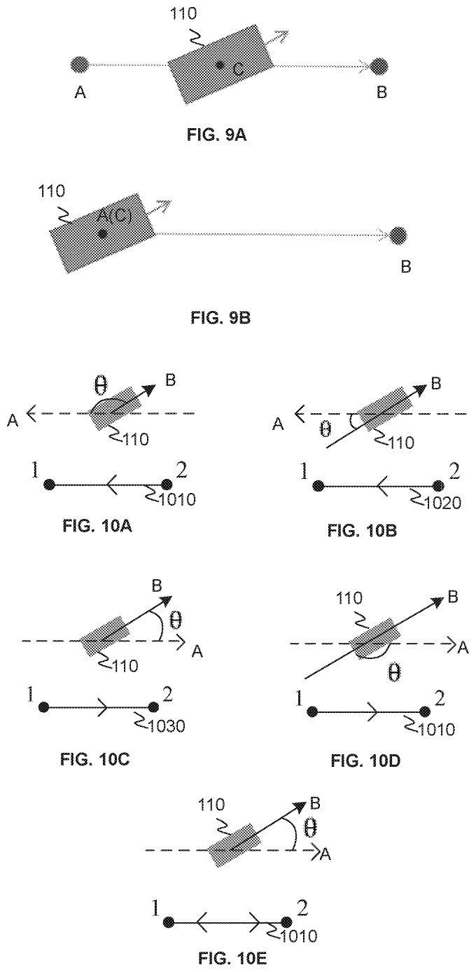

As still another example, referring to FIG. 9A, FIG. 9A is a schematic diagram illustrating an exemplary third position relationship between a current position of a moveable subject and a path segment according to some embodiments of the present disclosure. As shown in FIG. 9A, the moveable subject 110 is located on a path segment AB other than path nodes A and B. At this time, a distance cost relating to a distance between a current position of the moveable subject 110 and the path segment AB is equal to 0.

As still another example, referring to FIG. 9B, FIG. 9B is a schematic diagram illustrating an exemplary fourth position relationship between a current position of a moveable subject and a path segment according to some embodiments of the present disclosure. As shown in FIG. 9B, a reference point C of the moveable subject 110 coincides or substantially coincides with a path node A of a path segment AB. That is, the moveable subject 110 is located on the path node A of the path segment AB. At this time, a distance cost relating to a distance between a current position of the moveable subject 110 and the path segment AB is equal to 0.

In 704, the processing device 120 (e.g., the determination module 220) may determine, based on the posture information of the moveable subject, an angle cost relating to an angle between an orientation of the moveable subject and an orientation of the path segment.

In some embodiments, the processing device 120 may determine the orientation of the moveable subject based on the posture information of the moveable subject, and determine the orientation of the path segment based on the path map. Further, the processing device 120 may determine the angle between the orientation of the moveable subject and the orientation of the path segment.

Merely by way of example, referring to FIG. 10A, a path segment 1010 is unidirectional as indicated by an arrow A and directs from a path node 2 to a path node 1, an orientation of the moveable subject 110 is parallel to an arrow B, and the moveable subject 110 moves along the arrow B. An angle between the orientation of the moveable subject 110 and the orientation of the path segment 1010 may be an angle θ.

As another example, referring to FIG. 10B, a path segment 1020 is unidirectional as indicated by an arrow A and directs from a path node 2 to a path node 1, an orientation of the moveable subject 110 is parallel to an arrow B, and the moveable subject 110 moves along an opposite direction of the arrow B. An angle between the orientation of the moveable subject 110 and the orientation of the path segment 1020 may be an angle θ.

As still another example, referring to FIG. 10C, a path segment 1030 is unidirectional as indicated by an arrow A and directs from a path node 1 to a path node 2, an orientation of the moveable subject 110 is parallel to an arrow B, and the moveable subject 110 moves along the arrow B. An angle between the orientation of the moveable subject 110 and the orientation of the path segment 1030 may be an angle θ.

As still another example, referring to FIG. 10D, a path segment 1040 is unidirectional as indicated by an arrow A and directs from a path node 1 to a path node 2, an orientation of the moveable subject 110 is parallel to an arrow B, and the moveable subject 110 moves along an opposite direction of the arrow B. An angle between the orientation of the moveable subject 110 and the orientation of the path segment 1040 may be an angle θ.

As still another example, referring to FIG. 10E, a path segment 1050 is bidirectional as indicated by an arrow A, an orientation of the moveable subject 110 is parallel to an arrow B, and the moveable subject 110 moves parallel to an arrow B (e.g., along the arrow B or along an opposite direction of the arrow B). An angle between the orientation of the moveable subject 110 and the orientation of the path segment 1050 may be an angle θ.

In some embodiments, the processing device 120 may determine the angle cost based on the angle between the orientation of the moveable subject and the orientation of the path segment. For example, the processing device 120 may designate the angle as the angle cost.

In 706, the processing device 120 (e.g., the determination module 220) may determine, based on the distance cost and the angle cost, a first travel cost from the current position to the path segment.

In some embodiments, the processing device 120 may transform the angle cost into a second distance cost. For example, the processing device 120 may determine a time cost by directing the moveable subject to compensate for the angle cost (e.g., rotate for the angle cost), and determine the second distance cost based on the time cost and a moving speed of the moveable subject (e.g., the second distance cost is the product of the time cost and the moving speed).

Then, the processing device 120 may determine the first travel cost based on the distance cost and the second distance cost. For example, the processing device 120 may determine the first travel cost by weighted summing the distance cost and the second distance cost. A first weight corresponding to the distance cost may be the same as or different from a second weight corresponding to the second distance cost. The first weight and the second weight may be determined based on a system default setting, or set manually by a user.

It should be noted that the determination of the first travel cost based on the distance cost and the second distance cost is provided for the purposes of illustration, and is not intended to limit the scope of the present disclosure. For example, the processing device 120 may determine a first time cost corresponding to the distance between the current position of the moveable subject and the path segment and a second time cost corresponding to the angle between the orientation of the moveable subject and the orientation of the path segment, and determine the first travel cost based on the first time cost and the second time cost.

In some embodiments, the processing device 120 may determine the first travel cost further based on whether there is a roadblock along a path from the current position to the path segment. For example, the processing device 120 may obtain sensing data captured by one or more sensors (e.g., the at least one positioning device 140) mounted on the moveable subject or mounted in a preset scenario where the moveable subject is located, and determine whether there is a roadblock along the path from the current position to the path segment based on the sensing data. In response to determining that there is a roadblock along the path, the processing device 120 may update the distance cost and the angle cost. For example, the processing device 120 may generate the updated distance cost and the updated angle cost by multiplying the distance cost and the angle cost by roadblock coefficient(s), respectively. The roadblock coefficient corresponding to the distance cost may be the same as or different from the roadblock coefficient corresponding to the angle cost. The processing device 120 may determine the first travel cost from the current position to the path segment based on the updated distance cost and the updated angle cost.

By considering whether there is a roadblock along the path from the current position to the path segment, the accuracy of the first travel cost can be improved, thereby improving the accuracy of the determination of the target starting node and the path planning.

It should be noted that the path segment is taken as an example to describe the determination of the first travel cost of the path segment, and not intended to limit the scope of the present disclosure. For example, a first travel cost of a candidate path segment and/or a first travel cost of a target path segment may be determined according to the process 700.

FIG. 11 is a schematic diagram illustrating an exemplary process 1100 for determining a target start node from multiple candidate starting nodes according to some embodiments of the present disclosure.

As illustrated in FIG. 11, for each of multiple candidate starting nodes (e.g., 1102, 1112, etc.), whether there is an accessible path from the candidate starting node to a target position may be determined. For example, if there is an accessible path from the candidate starting node 1102 to the target position, a planned path 1104 from the candidate starting node 1102 to the target position may be generated based on a path map, and a second travel cost 1106 from the candidate starting node 1102 to the target position based on the planned path 1104.

In some embodiments, the planned path 1104 may include multiple planned path segments, and traffic conditions of the multiple planned path segments may affect whether the planned path 1104 is a suitable planned path for the moveable subject. Therefore, the planned path 1104 may be updated based on the multiple planned path segments. For example, reference information relating to the multiple planned path segments may be obtained. The reference information may be used to reflect a traffic condition of each of the multiple planned path segments. For example, the reference information of each of the multiple planned path segments may include posture information, moving information, etc., of other subject(s) in the planned path segment, a congestion condition of the planned path segment in historical data, roadblock information of the planned path segment, or the like, or any combination thereof. An accessible probability of each of the multiple planned path segments may be determined based on the reference information, and the planned path 1104 may be updated based on the accessible probability of each of the multiple planned path segments.

For example, probabilities may be determined for abnormal conditions relating to the reference information, and the accessible probability of the planned path segment may be determined based on the probabilities. Merely by way of example, assuming that a probability of a condition that another subject is located in the planned path segment is 10%, a probability of a condition that a congestion condition of the planned path segment occurs at a current time in the historical data is 20%, and a probability of a condition that a roadblock is located in the planned path segment is 15%, the accessible probability of the planned path segment may be determined by subtracting corresponding probabilities from 100% (i.e., 100%−10%−15%−20%=55%).

As another example, the processing device 120 may determine the accessible probability of the planned path segment through a trained machine learning model (e.g., a probability determination model). For example, the processing device 120 may input the planned path segment (e.g., coordinates of path nodes of the planned path segment) and/or the reference information relating to the planned path segment into the probability determination model, and the probability determination model may generate the accessible probability of the planned path segment. In some embodiments, the probability determination model may be trained based on a plurality of first training samples. Each first training sample may include a sample planned path segment, sample reference information relating to the sample planned path segment, and a ground truth accessible probability corresponding to the sample planned path segment. For example, the probability determination model may be obtained by training, based on a dice loss, a first initial model using the plurality of first training samples.

Then, the processing device 120 may determine whether the planned path 1104 needs to be updated based on the accessible probability of the planned path segment and a probability threshold. For example, if the probability threshold is 60%, the planned path 1104 or the above planned path segment needs to be updated. Alternatively, if the probability threshold is 30%, the planned path 1104 or the above planned path segment does not need to be updated. In some embodiments, the probability threshold may be determined based on a system default setting, or set manually by a user.

If the planned path 1104 includes the planned path segment whose accessible probability is less than the probability threshold, the processing device 120 may update the planned path 1104 by replacing the planned path segment. For example, the processing device 120 may replace the planned path segment with other path segments connecting path nodes of the planned path segment, and an accessible probability of the other path segments may be higher than the probability threshold.

In some embodiments, the processing device 120 may update the planned path 1104 through a trained machine learning model (e.g., a path updating model). For example, the processing device 120 may input the planned path 1104 (e.g., coordinates of path nodes of the planned path 1104) and the reference information relating to the multiple planned path segments in the planned path 1104 into the path updating model, and the path updating model may generate a result relating to the planned path 1104. The result may include the planned path 1104 (i.e., the planned path 1104 does not need to be updated), the updated planned path 1104 (i.e., the planned path 1104 needs to be updated and has been updated), and a blank result (i.e., the planned path 1104 needs to be updated but no updated planned path 1104 can be generated). In some embodiments, the path updating model may be trained based on a plurality of second training samples. Each second training sample may include a sample planned path from a sample starting node to a sample target position, sample reference information relating to sample planned path segments in the sample planned path, a sample path map, and a ground truth planned path corresponding to the sample planned path. For example, the path updating model may be obtained by training, based on a second dice loss, a second initial model using the plurality of second training samples.

The second travel cost 1106 may be determined based on the updated planned path 1104. If there is no accessible path from the candidate starting node 1102 to the target position, no planned path 1104 and no second travel cost 1106 may be generated.

Similarly, if there is an accessible path from the candidate starting node 1112 to the target position, a planned path 1114 from the candidate starting node 1112 to the target position may be generated based on a path map, and a second travel cost 1116 from the candidate starting node 1112 to the target position based on the planned path 1114.

A target start node 1150 may be determined from the multiple candidate starting nodes (e.g., 1102, 1112, etc.) based on the second travel costs (e.g., 1106, 1116, etc.) of the multiple candidate starting nodes (e.g., 1102, 1112, etc.). For example, the processing device 120 may designate a candidate starting node corresponding to a minimum second travel cost among the second travel costs (e.g., 1106, 1116, etc.) as the target start node 1150. As another example, the processing device 120 may designate a candidate starting node corresponding to a second travel cost that is first generated (e.g., the second travel cost 1106) as the target start node 1150.

In some embodiments, the processing device 120 may determine the target start node 1150 based on a total travel cost of each of multiple candidate starting nodes. The total travel cost of a candidate starting node refers to a moving resource consumed by moving the moveable subject from a current position to the target position. For example, for each of the multiple candidate starting nodes, the processing device 120 may determine a fourth travel cost from the current position to the candidate starting node, and determine the total travel cost corresponding to the candidate starting node based on the second travel cost and the fourth travel cost of the candidate starting node. For instance, the processing device 120 may determine the total travel cost by weighted summing the second travel cost and the fourth travel cost. A third weight corresponding to the second travel cost may be the same as or different from a fourth weight corresponding to the fourth travel cost. The third weight and the fourth weight may be determined based on a system default setting, or set manually by a user. Further, the processing device 120 may designate the candidate starting node having the lowest total travel cost as the target start node.

Processes 300, 700, and 1100 may be implemented in the path planning system 100 illustrated in FIG. 1. For example, the processes 300, 700, and 1100 may be stored in the storage device 130 as a form of instructions, and invoked and/or executed by the processing device 120. The operations of the illustrated process presented below are intended to be illustrative. In some embodiments, the processes 300, 700, and 1100 may be accomplished with one or more additional operations not described, and/or without one or more of the operations discussed. Additionally, the order in which the operations of the processes 300, 700, and 1100 as illustrated in FIGS. 3, 7, and 11 are not intended to be limiting.

FIG. 12 is a schematic diagram illustrating an exemplary electronic device 1200 according to some embodiments of the present disclosure.

The electronic device 1200 may include a microcomputer, a server, a laptop, a tablet, or the like, or any combination thereof. As illustrated in FIG. 12, the electronic device 1200 may include at least one processor 1210 and at least one storage device 1220 coupled to the at least one processor 1210. A specific connection medium between the processor(s) 1210 and the storage device(s) 1220 is not limited in the embodiments of the present disclosure. As illustrated in FIG. 12, the processor(s) 1210 and the storage device(s) 1220 may be connected via bus 1230. It should be noted that the description of the bus 1230 is provided for the purposes of illustration, and not intended to limit the scope of the present disclosure. The bus 1230 may include an address bus, a data bus, a control bus, etc. In some embodiments, the processor(s) 1210 may also be referred to as a controller, which is not limited herein.

The storage device(s) 1220 may store programs and/or instructions for implementing the processes in the above embodiments of the present disclosure. The processor(s) 1210 may be configured to execute the programs and/or instructions stored in the storage device(s) 1220 to implement operations of the processes in the above embodiments of the present disclosure. The processor(s) 1210 may include a central processing unit (CPU). The processor(s) 1210 may be an integrated circuit chip that can process a signal. The processor(s) 1210 may include a general processor, a digital signal processor (DSP), an application-specific integrated circuit (ASIC), a field-programmable gate array (FPGA) or other programmable logic devices, a discrete gate or transistor logic devices, a discrete hardware component, etc. The general processor may be a microprocessor, or any conventional processor.

Some embodiments of the present disclosure also provide a computer-readable storage medium. Referring to FIG. 13, a computer-readable storage medium 1300 may store computer-executable instructions 1310, and the computer-executable instructions 1310 may be used to cause a computer to implement the processes in the above embodiments of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure.

Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for path planning, implemented on a computing device having at least one processor and at least one storage device, the method comprising:
obtaining posture information of a moveable subject and a path map, the moveable subject being located at a current position in the path map and planning to go to a target position in the path map, the path map including path nodes and path segments, and each of the path segments connecting two path nodes of the path nodes;
determining, based on the posture information of the moveable subject, one or more target path segments from the path segments in the path map, wherein a first travel cost from the current position of the moveable subject to each of the one or more target path segments satisfies a first condition;
determining one or more candidate starting nodes based on the one or more target path segments; and
determining a target starting node from the one or more candidate starting nodes, a second travel cost from the target starting node to the target position satisfying a second condition.

2. The method of claim 1, wherein the determining, based on the posture information of the moveable subject, one or more target path segments from the path segments in the path map includes:
determining, based on the posture information of the moveable subject, a path node range in the path map;
determining one or more candidate path segments from the path segments, each of the one or more candidate path segments including at least one path node within the path node range; and
selecting the one or more target path segments from the one or more candidate path segments.

3. The method of claim 2, wherein the selecting the one or more target path segments from the one or more candidate path segments includes:
for each of the one or more candidate path segments,
determining, based on the posture information of the moveable subject, a first travel cost from the current position to the candidate path segment;
determining whether the first travel cost of the candidate path segment satisfies the first condition; and
in response to determining that the first travel cost of the candidate path segment satisfies the first condition, designating the candidate path segment as one of the one or more target path segments.

4. The method of claim 3, wherein the determining the first travel cost from the current position to the candidate path segment includes:
determining, based on the posture information of the moveable subject, a distance cost relating to a distance between the current position and the candidate path segment;
determining, based on the posture information of the moveable subject, an angle cost relating to an angle between an orientation of the moveable subject and an orientation of the candidate path segment; and
determining, based on the distance cost and the angle cost, the first travel cost from the current position to the candidate path segment.

5. The method of claim 4, wherein the determining, based on the distance cost and the angle cost, the first travel cost from the current position to the candidate path segment includes:
transforming the angle cost into a second distance cost; and
determining the first travel cost based on the distance cost and the second distance cost.

6. The method of claim 4, wherein the determining the first travel cost from the current position to the candidate path segment includes:
obtaining sensing data captured by one or more sensors mounted on the moveable subject;
determining whether there is a roadblock along a path from the current position to the candidate path segment based on the sensing data;
in response to determining that there is a roadblock along the path, updating the distance cost and the angle cost;
determining the first travel cost from the current position to the candidate path segment based on the updated distance cost and the updated angle cost.

7. The method of claim 3, wherein the selecting the one or more target path segments from the one or more candidate path segments further includes:
for each of the one or more candidate path segments,
determining a third travel cost from the current position to each path node in the candidate path segment; and
determining whether the third travel cost from the current position to each path node in the candidate path segment satisfies a third condition, wherein the in response to determining that the first travel cost of the candidate path segment satisfies the first condition, designating the candidate path segment as one of the one or more target path segments includes:
in response to determining that the first travel cost of the candidate path segment satisfies the first condition and the third travel cost from the current position to each path node in the candidate path segment satisfies the third condition, designating the candidate path segment as one of the one or more target path segments.

8. The method of claim 1, wherein the determining one or more target path segments from the path segments in the path map includes:
selecting one or more path nodes from the path nodes in the path map, wherein each selected path node has no accessible path to the target position;
obtaining a filtered path map by removing the one or more selected path nodes from the path map; and
determining the one or more target path segments from the path segments in the filtered path map based on the posture information of the moveable subject.

9. The method of claim 1, wherein the one or more candidate starting nodes include multiple candidate starting nodes, and the target starting node is determined from the multiple candidate starting nodes by:
determining a fourth travel cost from the current position to each candidate starting node;
determining a node sequence by sorting the candidate starting nodes based on the fourth travel costs; and
sequentially processing the candidate starting nodes in the node sequence until a second travel cost from the currently processed candidate starting node to the target position satisfies the second condition.

10. The method of claim 1, wherein the one or more candidate starting nodes include multiple candidate starting nodes, and the target starting node is determined from the multiple candidate starting nodes by:
for each of the multiple candidate starting nodes,
determining whether there is an accessible path from the candidate starting node to the target position;
in response to determining that there is an accessible path from the candidate starting node to the target position, determining a second travel cost from the candidate starting node to the target position based on a planned path from the candidate starting node to the target position based on the path map; and
determining the target starting node from the multiple candidate starting nodes based on the second travel costs of the multiple candidate starting nodes.

11. The method of claim 10, wherein the planned path includes multiple planned path segments, and the determining the second travel cost from the candidate starting node to the target position comprises:
obtaining reference information relating to the multiple planned path segments;
determining an accessible probability of each of the multiple planned path segments based on the reference information;
updating the planned path based on the accessible probability of each of the multiple planned path segments; and
determining the second travel cost based on the updated planned path.

12. The method of claim 10, wherein the determining the target starting node from the multiple candidate starting nodes includes:
for each of the multiple candidate starting nodes,
determining a fourth travel cost from the current position to the candidate starting node; and
determining a total travel cost corresponding to the candidate starting node based on the second travel cost and the fourth travel cost of the candidate starting node; and
designating the candidate starting node having the lowest total travel cost as the target starting node.

13. A system for path planning, comprising:
at least one storage device including a set of instructions; and
at least one processor configured to communicate with the at least one storage device, wherein when executing the set of instructions, the at least one processor is configured to direct the system to perform operations including:
obtaining posture information of a moveable subject and a path map, the moveable subject being located at a current position in the path map and planning to go to a target position in the path map, the path map including path nodes and path segments, and each of the path segments connecting two path nodes of the path nodes;
determining, based on the posture information of the moveable subject, one or more target path segments from the path segments in the path map, wherein a first travel cost from the current position of the moveable subject to each of the one or more target path segments satisfies a first condition;
determining one or more candidate starting nodes based on the one or more target path segments; and
determining a target starting node from the one or more candidate starting nodes, a second travel cost from the target starting node to the target position satisfying a second condition.

14. The system of claim 13, wherein the determining, based on the posture information of the moveable subject, one or more target path segments from the path segments in the path map includes:
determining, based on the posture information of the moveable subject, a path node range in the path map;
determining one or more candidate path segments from the path segments, each of the one or more candidate path segments including at least one path node within the path node range; and
selecting the one or more target path segments from the one or more candidate path segments.

15. The system of claim 14, wherein the selecting the one or more target path segments from the one or more candidate path segments includes:
for each of the one or more candidate path segments,
determining, based on the posture information of the moveable subject, a first travel cost from the current position to the candidate path segment;
determining whether the first travel cost of the candidate path segment satisfies the first condition; and
in response to determining that the first travel cost of the candidate path segment satisfies the first condition, designating the candidate path segment as one of the one or more target path segments.

16. The system of claim 15, wherein the determining the first travel cost from the current position to the candidate path segment includes:
determining, based on the posture information of the moveable subject, a distance cost relating to a distance between the current position and the candidate path segment;
determining, based on the posture information of the moveable subject, an angle cost relating to an angle between an orientation of the moveable subject and an orientation of the candidate path segment; and
determining, based on the distance cost and the angle cost, the first travel cost from the current position to the candidate path segment.

17. The system of claim 16, wherein the determining, based on the distance cost and the angle cost, the first travel cost from the current position to the candidate path segment includes:
transforming the angle cost into a second distance cost; and
determining the first travel cost based on the distance cost and the second distance cost.

18. The system of claim 16, wherein the determining the first travel cost from the current position to the candidate path segment includes:
obtaining sensing data captured by one or more sensors mounted on the moveable subject;
determining whether there is a roadblock along a path from the current position to the candidate path segment based on the sensing data;
in response to determining that there is a roadblock along the path, updating the distance cost and the angle cost;
determining the first travel cost from the current position to the candidate path segment based on the updated distance cost and the updated angle cost.

19. The system of claim 15, wherein the selecting the one or more target path segments from the one or more candidate path segments further includes:
for each of the one or more candidate path segments,
determining a third travel cost from the current position to each path node in the candidate path segment; and
determining whether the third travel cost from the current position to each path node in the candidate path segment satisfies a third condition, wherein the in response to determining that the first travel cost of the candidate path segment satisfies the first condition, designating the candidate path segment as one of the one or more target path segments includes:
in response to determining that the first travel cost of the candidate path segment satisfies the first condition and the third travel cost from the current position to each path node in the candidate path segment satisfies the third condition, designating the candidate path segment as one of the one or more target path segments.

20. A non-transitory computer readable medium, comprising executable instructions that, when executed by at least one processor, direct the at least one processor to perform a method, the method comprising:
obtaining posture information of a moveable subject and a path map, the moveable subject being located at a current position in the path map and planning to go to a target position in the path map, the path map including path nodes and path segments, and each of the path segments connecting two path nodes of the path nodes;
determining, based on the posture information of the moveable subject, one or more target path segments from the path segments in the path map, wherein a first travel cost from the current position of the moveable subject to each of the one or more target path segments satisfies a first condition;
determining one or more candidate starting nodes based on the one or more target path segments; and
determining a target starting node from the one or more candidate starting nodes, a second travel cost from the target starting node to the target position satisfying a second condition.
